(19) United States
(12) Patent Application Publication
(10) Pub. No.: US 2014/0009834 A1
(43) Pub. Date: Jan. 9, 2014

(54) NOVEL ANTIREFLECTIVE COATINGS WITH GRADED REFRACTIVE INDEX

(71) Applicant: Nikhil D. Kalyankar, Hayward, CA (US)

(72) Inventor: Nikhil D. Kalyankar, Hayward, CA (US)

(73) Assignee: Intermolecular, Inc., San Jose, CA (US)

(21) Appl. No.: 13/542,510

(22) Filed: Jul. 5, 2012

(51) Int. Cl. G02B 1/11

(52) U.S. Cl. 359/586

(57) ABSTRACT

One or more coated layers having a variation in index of refraction can provide improvements in antireflection property. For example, different sol gel formulations can be employed in a multiple coating step approach to achieve a desired gradation of index of refraction using individual or combinations of particles containing sol formulations. Different organic porosity forming agents, surfactants and binders can be used to provide further control in forming the gradual index of refraction. In addition, different heat and chemical treatment conditions could also provide control over the gradation of index of refraction.

### FIELD OF THE INVENTION

Embodiments of the invention relate generally to methods and apparatuses for forming antireflection layers on substrates.

### BACKGROUND OF THE INVENTION

Coatings that provide low reflectivity or a high percent transmission over a broad wavelength range of light are desirable in many applications including semiconductor device manufacturing, solar cell manufacturing, glass manufacturing, and energy cell manufacturing. The refractive index of a material is a measure of the speed of light in the material which is generally expressed as a ratio of the speed of light in vacuum relative to that in the material. Low reflectivity coatings generally have a refractive index (n) in between air (n=1) and glass (n˜1.5).

An antireflective (AR) coating is a type of low reflectivity coating applied to the surface of a transparent article to reduce reflectivity of visible light from the article and enhance the transmission of such light into or through the article thus decreasing the refractive index. One method for decreasing the refractive index and enhancing the transmission of light through an AR coating is to increase the porosity of the antireflective coating. Porosity is a measure of the void spaces in a material. Although such antireflective coatings have been generally effective in providing reduced reflectivity over the visible spectrum, the coatings have suffered from deficiencies when used in certain applications. For example, porous AR coatings which are used in solar applications are highly susceptible to moisture absorption. Moisture absorption may lead to an increase in the refractive index of the AR coating and corresponding reduction in light transmission.

Thus, there is a need for AR coatings which exhibit increased transmission, reliability and durability.

### SUMMARY OF THE DISCLOSURE

In some embodiments, the present invention discloses methods and apparatuses for a coated article comprising one or more coated layers having a variation in index of refraction. For example, the varying-index layers can have index of refraction between those of air and of the underlying substrate to improve the antireflective property of the coated article. In some embodiments, the coated article comprises a transparent substrate, such as a glass substrate, together with the varying-index layers having index of refraction gradually changing from 1.5 (index of refraction of glass, for the layer nearest to the glass substrate) to 1 (index of refraction of air, for the outermost layer farthest from the glass substrate).

In some embodiments, the varying-index layers can be coated on one or two sides of the transparent substrate. For example, the varying-index layers can be coated on one side of the substrate, wherein the other side can comprise a single index of refraction layer, or other varying-index layers. Alternatively, the other side can be used for other purposes, such as fabricating photo devices. In some embodiments, the varying-index layers can be coated on both sides of the substrate, further improving the properties of the substrate upon light exposure.

In some embodiments, the present invention discloses methods and processes to form one or more coated layers having a variation in index of refraction. A combination of sol formulations containing mixed particles can lead to layers with graded index of refraction. Alternatively, different sol formulations can be employed in a multiple coating steps approach to achieve a desired gradation of index of refraction using individual or combinations of particles in the sol formulations.

In some embodiments, different organic porosity forming agents, surfactants and binders can be used to provide control in forming the gradual index of refraction. In some embodiments, different sol formulations with different binders and organic porosity forming agents can be used.

In some embodiments, the present invention discloses temperature processes to achieve coating having gradual index of refraction. In some embodiments, different heat treatment conditions after application of sol gel AR coating (single or multilayered) could provide control over the gradation of index of refraction.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 illustrates an exemplary antireflective layer according to some embodiments of the present invention.

FIGS. 2A-2B illustrate an exemplary behavior of an optimized antireflective layer according to some embodiments of the present invention.

FIGS. 3A-3B illustrate exemplary multilayer coatings according to some embodiments of the present invention.

FIGS. 4A-4C illustrate exemplary models for multilayer antireflective coatings according to some embodiments of the present invention.

FIGS. 5A-5B illustrate an exemplary behavior of the multilayer coatings according to some embodiments of the present invention.

FIGS. 6A-6D illustrate exemplary index of refraction distributions for multilayer coatings according to some embodiments of the present invention.

FIGS. 7A-7B illustrate an exemplary two side multilayer coatings of a substrate according to some embodiments of the present invention.

FIGS. 8A-8D illustrate exemplary configurations of multilayer coatings having variation in index of refraction according to some embodiments of the present invention.

FIG. 9 illustrates an exemplary flowchart to form an antireflective multilayer coating having variable index of refraction according to some embodiments of the present invention.

FIG. 10 illustrates another exemplary flowchart to form an antireflective multilayer coating having variable index of refraction according to some embodiments of the present invention.

FIG. 11 illustrates another exemplary flowchart to form an antireflective multilayer coating having variable index of refraction according to some embodiments of the present invention.

FIG. 12 illustrates an exemplary flowchart to form an antireflective multilayer coating having variable index of refraction according to some embodiments of the present invention.

### DETAILED DESCRIPTION OF THE PREFERRED EMBODIMENTS

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, the present invention discloses methods, and coated articles fabricated from the methods, to reduce reflected light coming from a transparent substrate. The methods comprise forming multiple layers or an integrated layer having an incremental change in index of refraction between the ambient and the substrate.

In some embodiments, the present invention discloses methods and apparatuses for a coated article comprising one or more coated layers having a variation in index of refraction. For example, the outermost layer disposed next to the air ambient can have an index of refraction close to that of air (i.e., about 1). The innermost layer disposed next to the glass substrate can have an index of refraction close to that of glass (i.e., about 1.5). The layers between the outermost layer and the innermost layer can have indices of refraction gradually changing from that of air to that of glass. The present layers having varying indices of refraction can have improved antireflective property, as compared to a single layer having a single index of refraction. The coated layers can comprise multiple discrete layers or an integrated layer having index of refraction incrementally changed from that of the air ambient to that of the substrate.

When light encounters a medium with a different index of refraction, a portion of the incoming light is reflected, which depends on the indices of refraction of both media. For example, when light travels from a first medium having a index of refraction n₀ to a second medium having an index of refraction nₛ, the reflection coefficient R, is defined as the ratio of the reflected light intensity and the incoming light intensity

$$R = {( \frac{{n}_{0} - {n}_{s}}{{n}_{0} + {n}_{s}} )}^{2}$$

The transmission coefficient T is complementary to the reflection coefficient, assuming negligible absorption and scattering

$$T = 1 - R = 1 - {( \frac{{n}_{0} - {n}_{s}}{{n}_{0} + {n}_{s}} )}^{2} = \frac{4 {n}_{0} {n}_{s}}{{( {n}_{0} + {n}_{s} )}^{2}}$$

For a single reflection of visible light travelling from air (n₀≈1.0) into common glass (nₛ≈1.5), the reflection coefficient is about 0.04, meaning about 96% of the light is transmitted with about 4% reflected from the glass surface.

To reduce the reflection, an antireflective layer can be deposited on the substrate. The index of refraction of the antireflective layer is designed to maximize the transmission of the incoming light.

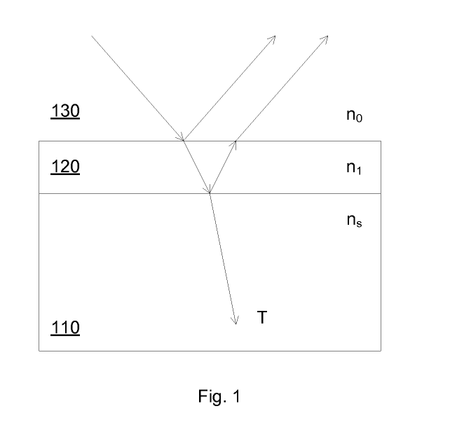

FIG. 1 illustrates an exemplary antireflective layer according to some embodiments of the present invention. An antireflective layer 120 is disposed on a glass substrate 110 facing the air ambient 130. The total transmission T of an incoming light is the product of the transmission through the two interfaces

$$T = \frac{4 {n}_{0} {n}_{1}}{{( {n}_{0} + {n}_{1} )}^{2}} \times \frac{4 {n}_{1} {n}_{s}}{{( {n}_{1} + {n}_{s} )}^{2}}$$

Optimizing the total transmission T, e.g., setting to zero the derivative of T with respect to n₁, the index of refraction n₁ of the antireflection layer 120 can be calculated to be

n₁=\sqrt{n₀nₛ}

The above analysis can be applied to an antireflective layer that can provide high transmission for a certain wavelength of light, such as in laser applications. For broadband applications, e.g., minimizing reflection for light having wavelengths between 400 nm and 1200 nm, the thickness and index of refraction of the antireflective layer 120 can be calculated to achieve an optimized average transmission, which typically has a maximum transmission at a certain range of wavelengths together with a maximum average transmission.

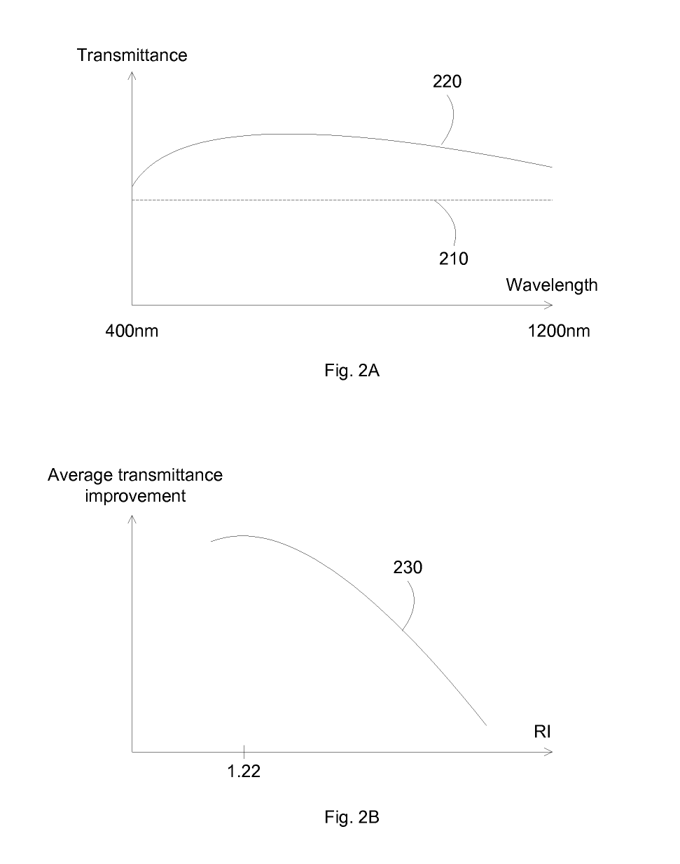

FIGS. 2A-2B illustrate an exemplary behavior of an optimized antireflective layer according to some embodiments of the present invention. In FIG. 2A, a transmittance curve 220 of a glass substrate having an antireflective layer is shown as a function of the wavelengths of the incoming light. A maximum transmittance is achieved at a middle range of the wavelengths, e.g., at about 650 nm, together with a small drop at both ends of the wavelength range, e.g., in the 400 nm range and in the 1200 nm range. For comparison, the transmittance through a glass substrate is essentially constant with respect to wavelength, shown as curve 210, representing a transmittance through a glass substrate without any antireflective layer.

In FIG. 2B, an average transmittance improvement of a glass substrate having an antireflective layer is shown as a function of the refractive index of the antireflective layer. A maximum transmittance improvement can be seen at the index of refraction of about 1.22, which corresponds to the optimal transmission as in the case of an incoming light having a single wavelength.

In some embodiments, the present invention discloses one or more layers, coated on a transparent substrate, that have variable indices of refraction to improve the antireflection property or to improve the transmission property.

In some embodiments, the present invention discloses multilayer antireflective coatings, for example, to further improve the broadband transmission of light, e.g., improving transmission of light having wavelengths in the 400-1200 nm range. In some embodiments, many layers of similar thicknesses and refractive indices changing from that of air to that of the substrate can be layered to allow for enhanced transmission for light in a broad range of wavelengths. Alternatively, the layers can have different thicknesses.

In some embodiments, the multilayer coatings comprise multiple discrete layers, each with an index of refraction between those of air and of the underlying substrate. In some embodiments, the multiple layers are arranged to form an incremental or gradual variation of index of refraction from the substrate outward. The gradual variation can be a stepwise change, resulting from the index of refraction abruptly changed between the multiple discrete layers. For example, the layers can have constant index of refraction, with the index of refraction from the multiple layers gradually decreasing from nearest to farthest from the substrate. The gradual variation can be a smooth change, wherein the layers can have varied indices of refraction, reducing the step jump of index of refraction between layers.

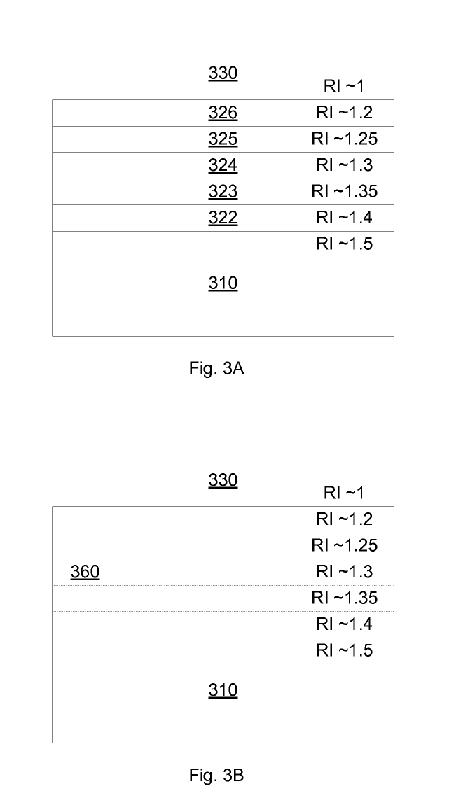

FIGS. 3A-3B illustrate exemplary multilayer coatings according to some embodiments of the present invention. In FIG. 3A, the multilayer coating comprises discrete layers 322-326, each with different index of refraction, which are disposed on a glass substrate 310. The layers are arranged in varying index of refraction. For example, layer 326 facing air ambient 330 has index of refraction 1.2, slightly increased from the index of refraction of 1 for air. Layer 322 facing the glass substrate 310 has an index of refraction of 1.4, slightly decreased from the index of refraction of 1.5 for glass. The layers in between, e.g., layer 323-325, have a gradual change in index of refraction from that of air to that of glass, for example, 1.25 for layer 325 to 1.35 for layer 323. The layers preferably have similar thickness, e.g., same designed thickness, for example, for ease of fabrication. In some embodiments, the multiple layers comprise two or more layers, such as 5 layers or more, and preferably greater than 8 layers. The thickness of the layers can be less than 300 nm, and preferably less than 200 nm. The variation of the index of refraction can be linear or non-linear.

In FIG. 3B, the multilayer coating comprises an integrated layer 360 disposed on a glass substrate 310. The integrated layer 360 has index of refraction incrementally changed between the two interfaces. Near the air ambient 330, the index of refraction of the integrated layer 360 is close to that of air, e.g., about 1.2. Near the glass substrate 310, the index of refraction of the integrated layer 360 is close to that of glass, e.g., about 1.4. The integrated layer 360 also comprises varying indices of refraction between the two outermost portions. The change of the index of refraction within the integrated layer 360 can be sharp, e.g., a step variation between different values of index of refraction. Alternatively, the change can be smooth, having a gradual variation of index of refraction within the integrated layer.

In some embodiments, the multilayer coating can comprise one or more integrated layers, or a combination of discrete layers and integrated layers.

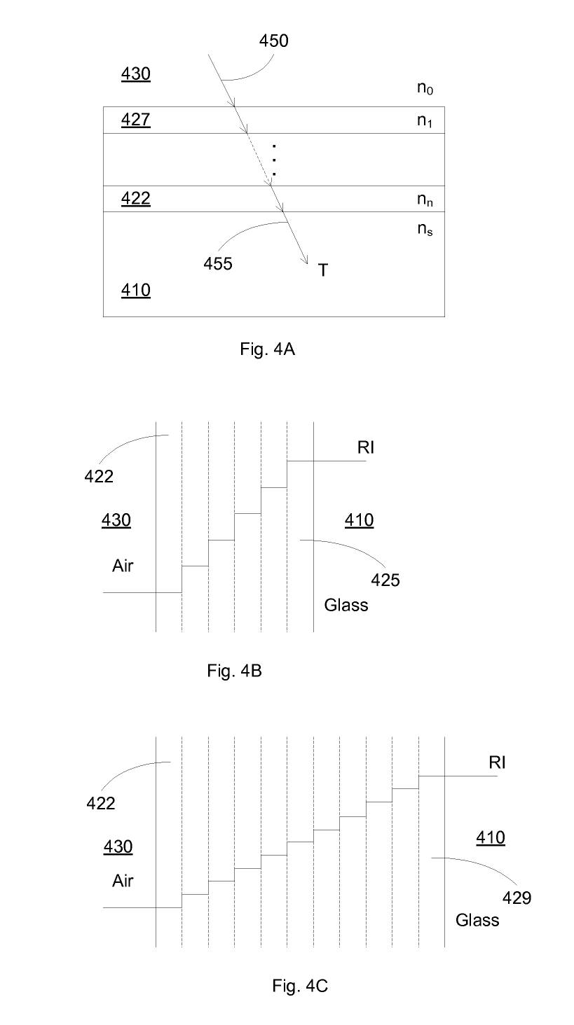

FIGS. 4A-4C illustrate exemplary models for multilayer antireflective coatings according to some embodiments of the present invention. In FIG. 4A, a transparent substrate, such as a glass substrate 410 having index of refraction nₛ, comprises multiple layers 422-427 deposited on the substrate surface, facing an air ambient 430. The multiple layers 422-427 each has different index of refraction n₁-nₙ, arranged so that n₀<n₁< . . . <nₙ<nₛ. Given an incoming light intensity 450, a transmission coefficient T 455 is calculated based on the multilayer 422-427.

The number of layers 422-427, together with the change in index of refraction for these layers, can be modeled to optimize the light transmittance, either in broad band mode, in average transmittance mode, or in certain ranges of wavelength. FIG. 4B shows 6 layers 422-425, with indices of refraction varying in a linear step-wise from that of air 430 to that of glass 410. FIG. 4B shows 11 layers 422-429, with indices of refraction varying in a linear step-wise from that of air 430 to that of glass 410.

The above description of multiple discrete layers with step-wise variation of index of refraction serves as an exemplary embodiment, and thus is not meant to be a limitation of the present invention. Other configurations are also within the scope of the present invention, including different profiles of index of refraction (e.g., smooth curve, step-wise smooth curve, linear curve or step-wise linear curve), integrated layers instead of discrete layers, and a combination of integrated layer and discrete layers.

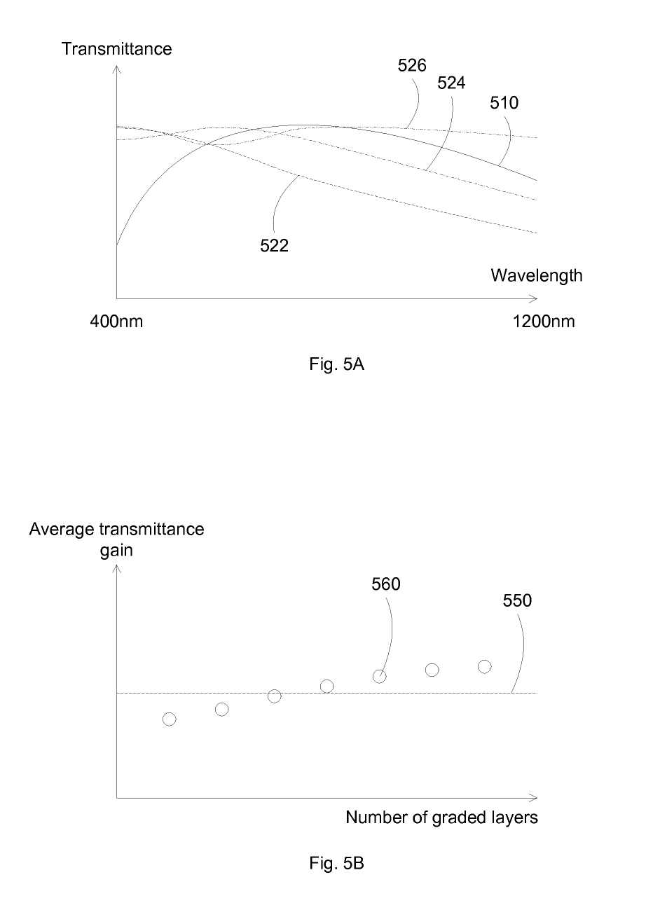

FIGS. 5A-5B illustrate an exemplary behavior of the multilayer coatings according to some embodiments of the present invention. In FIG. 5A, the light transmittance through the multilayer coatings, e.g., the transmittance coefficient as a percentage of the incoming intensity, are shown for the broad band range of wavelength, e.g., from 400 nm to 1200 nm. Three representative transmittance curves 522, 524 and 526 correspond to three different multilayer coatings, such as 15, 21 and 28 layers on a glass substrate. Transmittance curve 510 is also shown, which corresponds to a glass substrate having a single antireflective layer of 1.22 index of refraction.

The optical modeling shows that gradation in index of refraction improves optical transmittance over single layer homogeneous antireflective coating. For example, the multilayer coatings can have broader gain in transmittance, especially at lower wavelengths. The data shown is exemplary, and further gain in optical transmission can be achieved, including broad band gain and gains in selected wavelength ranges.

In some embodiments, the present invention discloses methods to optimize a light transmission through a transparent substrate by multilayer coatings. For example, an improvement in lower wavelength gain can be achieved by a small number of multilayer coatings having varying index of refraction. In some embodiments, less than 15 layers in multilayer coatings can offer significant gain in wavelengths ranges of less than 600 or 700 nm. Larger ranges of short wavelengths can be achieved with high number of layers, such as about 20 layers. Improvements in high wavelength transmission can be achieved with a large number of layers having varying index of refraction. For example, at higher than 20 layers in multilayer coatings, gains in ranges of long wavelengths, e.g., from 800 nm to 1200 nm, can be significantly increased. A smooth variation of index of refraction can offer improved gain in broad band wavelengths, e.g., in the range of 400 nm to 1200 nm.

In FIG. 5B, the average light transmittance gain through the multilayer coatings, e.g., the percentage gain as compared to a substrate without any antireflective layer, are shown for different number of layers in the multilayer coatings. The representative transmittance gain data 560 correspond to different multilayer coatings, such as between 15 and 28 layers on a glass substrate. Average transmittance curve 550 is also shown, which corresponds to a glass substrate having a single antireflective layer of 1.22 index of refraction. Curve 550 can represent a theoretical limitation in average optical transmittance improvement for a fixed index of refraction single layer antireflective coating, which is about 2.94%. With gradation of refractive index in the multilayer coatings, significant improvements in optical transmittance gain (>3.5%) can be achieved over single layer coating. For smaller number of graded layers, the average optical gain can be lower than the single layer coating, due to the loss in high wavelength range.

In some embodiments, the present invention discloses a multilayer coating having an index of refraction smoothly change within the coating, for example, to achieve an average optical gain better than a single layer antireflective coating having fixed index of refraction. The index of refraction can be smoothly or abruptly changed at the interface with the ambient and/or the substrate.

In some embodiments, the present invention discloses multilayer coatings having greater than about 10 layers, for example, to achieve an average optical gain better than a single layer antireflective coating having fixed index of refraction. In the present description, the number of layers also means to be the number of index of refraction in the antireflective layers. For example, 10 layers can refer to the index of refraction changed 10 times between the air interface and the substrate interface. The change of index of refraction can be smooth, step-wise constant, step-wise variation, or a combination thereof.

In some embodiments, the index of refraction of the multilayer coatings varies linearly or non-linearly from air to the substrate. The multilayer coatings can comprise discrete layers, each with a fixed index of refraction.

In some embodiments, the multilayer coatings comprise multiple layers with optional interface layers between the layers. For example, an interface layer can be disposed between each pair of two adjacent varying-index layers. Alternatively, some pairs of two adjacent varying-index layers comprise abrupt transitions of index of refraction.

In some embodiments, the multilayer coatings comprise an integrated layer with gradual varying index of refraction from the substrate to the air surface. Other configurations of varying-index layers are within the scope of the present invention, such as an integrated layer with gradual index of refraction disposed over or under multiple varying-index discrete layers.

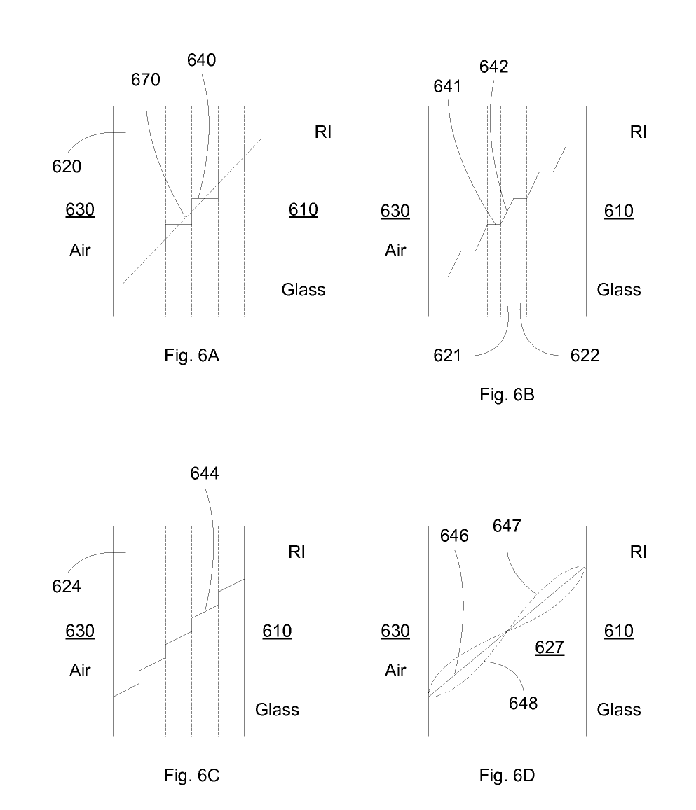

FIGS. 6A-6D illustrate exemplary index of refraction distributions for multilayer coatings according to some embodiments of the present invention. In FIG. 6A, multiple layers 620 are disposed on a glass substrate, with indices of refraction varying from that of air 630 to that of glass 610. The index of refraction can change in a step-wise manner 640. The overall change can be linear 670. Alternatively, the step-wise change can be non-linear. In FIG. 6B, an interface layer 621 can be disposed between two discrete layers 622, wherein the interface layer 621 comprises a gradual change 642 of index of refraction as compared to a fixed index of refraction 641 of the discrete layers 622. The interface layers can be formed by mixing between two adjacent discrete layers, resulting in a gradual change in index of refraction. In FIG. 6C, multiple layers 624 are disposed on a glass substrate, with index of refraction 644 gradually changed in each layer.

In FIG. 6D, an integrated layer 627 is disposed on the glass substrate, wherein the integrated layer 627 has a continuous change in index of refraction. The index of refraction can be linear 646, smoothly transitioning at the air or glass interface 648, or abruptly changing 647 at the air or glass interface.

Other profiles of index of refraction are also within the scope of the present invention, for example, including multiple layers having smooth change in index of refraction, or a combination of step-wise change and smooth change in index of refraction.

In some embodiments, the present invention discloses multilayer coatings having variable index of refraction on one or two sides of the transparent substrate. For example, the multilayer coatings can be coated on one side of the substrate. The other side of the substrate can comprise a device such as a photovoltaic device, or a single index of refraction layer. In some embodiments, the substrate can comprise multilayer coatings on both sides, further improving the properties of the substrate upon light exposure.

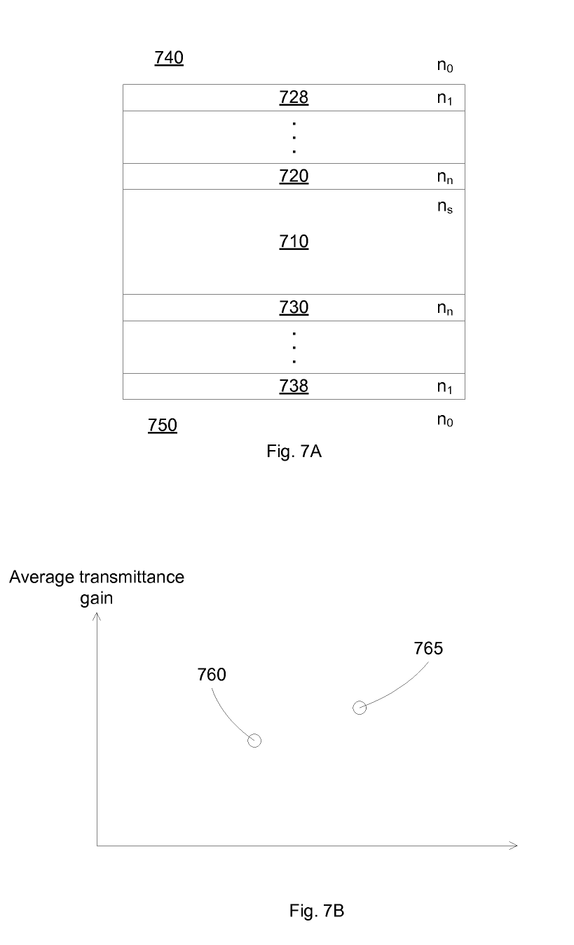

FIGS. 7A-7B illustrate an exemplary two side multilayer coatings of a substrate according to some embodiments of the present invention. A substrate 710, such as a glass substrate having index of refraction nₛ is sandwiched between multiple layers of antireflective coatings. For example, in one side facing ambient 740, the multilayer coatings comprises layer 720-728 having varying index of refraction nₙ to n₁, respectively. Similarly, in the opposite side facing ambient 750, the multilayer coatings comprises layer 730-738 having varying index of refraction nₙ to n₁, respectively. Alternatively, the multilayer coating 730-738 can have different index of refraction n′ₙ to n′₁. The double sided graded multilayer coating substrate can have improved average transmittance gain 765 of 7.24 as compared to gain 760 of a double sided single antireflective layer of 6.10.

In some embodiments, the present invention discloses methods and processes to form one or more coated layers having a variation in index of refraction using a sol-gel technique. A combination of sol formulations containing mixed particles can lead to layers with graded index of refraction. For example, particles of different sizes, shapes, porosity and materials can be used in a sol-gel approach to form gradation in refractive index in the antireflective multilayer coatings. In some embodiments, different sol gel formulations can be employed in a multiple coating step approach to achieve desired gradation of index of refraction using individual or combinations of particle-containing sol formulations. For example, multiple sol-gel coatings can be sequentially fabricated on the substrate. The multiple sol-gel coatings can be deposited one after another on the substrate, with optional drying steps, intermediate heat treatment steps or final heat treatment steps after one or more coatings. Further, different sol-gel processes, e.g., heat or chemical treatment can generate variation in the index of refraction of the sol-gel layers.

In some embodiments, the present invention discloses methods, and coated articles fabricated from the methods, to control the porosity of the antireflective coating to have incremental change in index of refraction from the ambient to the substrate. For example, the multilayer coatings can comprise particles of different sizes, shapes, densities, materials and porosities to obtain a variation in index of refraction. As a specific example, in some sol-gel processes, spherical particles can provide coatings having index of refraction between 1.25 and 1.37. Elongated particles can offer index of refraction between 1.18 and 1.40. Disc shape particles or porous or hollow silica nanoparticles can offer index of refraction between 1.2 and 1.5.

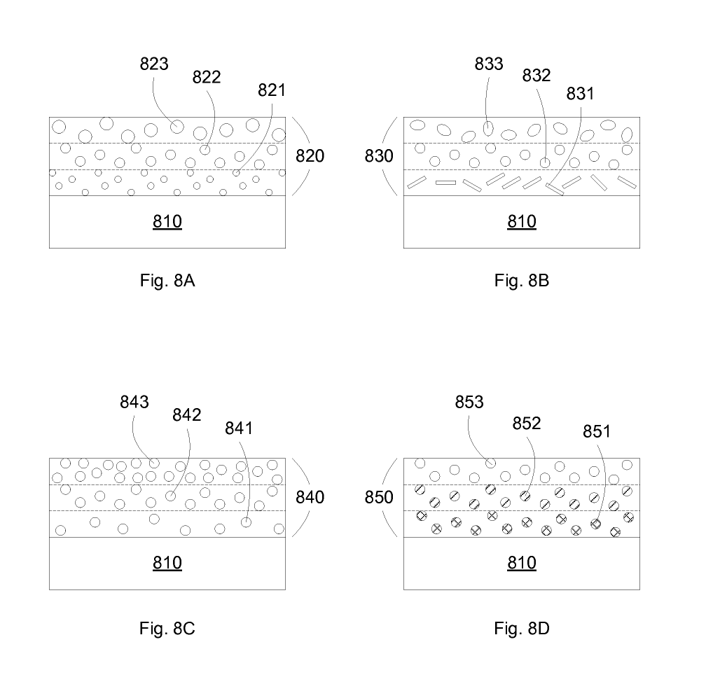

FIGS. 8A-8D illustrate exemplary configurations of multilayer coatings having variation in indices of refraction according to some embodiments of the present invention. In FIG. 8A, a multilayer coating 820 comprises pores 821-823 having different pore sizes, gradually changing from the substrate 810 to the ambient. The arrangement of the different pore sizes can provide a variation in index of refraction for the multilayer coating 820. As shown, the pores form discrete layers, but other configurations can be used, such as intermixed and integrated layers. For example, some small pores can be present at the outermost portion of the multilayer coating 820, as well as large pores at the innermost portion, as long as the index of refraction satisfies a desired profile for the antireflective coating.

In FIG. 8B, a multilayer coating 830 comprises particles 831-833 having different sizes or shapes, gradually changing from the substrate 810 to the ambient. The arrangement of the different particle sizes and shapes can provide a variation in index of refraction for the multilayer coating 830. As shown, the particles form discrete layers, but other configurations can be used, such as intermixed and integrated layers. The particles can have one dimension between 10 and 200 nanometers. The particles may be selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

In FIG. 8C, a multilayer coating 840 comprises pores 841-843 arranges in different densities, gradually changing from the substrate 810 to the ambient. The arrangement of the different pore densities can provide a variation in index of refraction for the multilayer coating 840. As shown, the pores form discrete layers, but other configurations can be used, such as intermixed and integrated layers.

In FIG. 8D, a multilayer coating 850 comprises particles 851-853 having different materials, gradually changing from the substrate 810 to the ambient. The arrangement of the different particle materials can provide a variation in index of refraction for the multilayer coating 850. As shown, the particles form discrete layers, but other configurations can be used, such as intermixed and integrated layers.

In some embodiments, the present invention discloses methods and structures for forming variable refractive index coatings on substrates. In some embodiments, the present invention discloses sol-gel processes, and coated articles formed by sol-gel processes, for forming variable refractive index coatings on transparent substrates.

In general, a sol-gel process is a process where a wet formulation (commonly called the sol or sol-formulation) is dried to form a gel coating (e.g., gel-formulation) having both liquid and solid characteristics. The gel coating is then heat treated to form a solid material. The gel coating or the solid material may be formed by applying a thermal treatment to the sol. This technique is widely used for antireflective coatings because it is easy to implement and provides films of uniform composition and thickness.

In some embodiments, the present invention discloses methods to form multilayer coatings having variable index of refraction using sol-gel processes.

In some embodiments, the coating may be a single coating. In alternate embodiments, the coating may be formed of multiple coatings on the same substrate. In such an embodiment, the coating, gel-formation, and annealing may be repeated to form a multilayered coating with any number of layers. The multilayer coatings may form a coating with graded porosity. For example, in certain embodiments it may be desirable to have a coating which has a higher porosity adjacent to air and a lower porosity adjacent to the substrate surface. A graded coating may be achieved by modifying various parameters, such as, the type of sol formulations, the anneal time, and the anneal temperature.

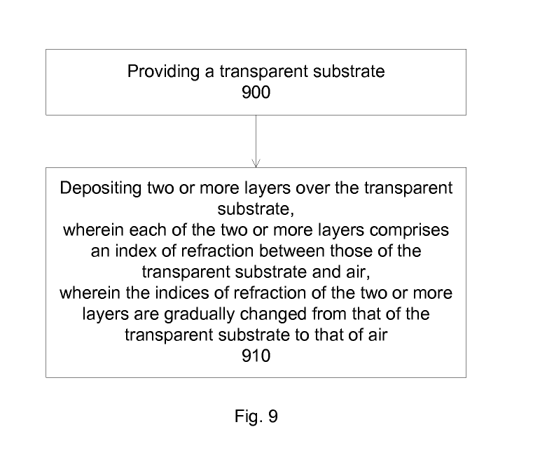

FIG. 9 illustrates an exemplary flowchart to form an antireflective multilayer coating having variable index of refraction according to some embodiments of the present invention. In operation 900, a transparent substrate is provided. In operation 910, two or more layers are deposited over the transparent substrate, wherein each of the two or more layers comprises an index of refraction between that of the transparent substrate and air, wherein the indices of refraction of the two or more layers are gradually changed from that of the transparent substrate to that of air. In some embodiments, the number of layers is selected to achieve a desired objective, such as less than about 20 layers for low wavelength transmission, or greater than 10 layers for broad band transmission or for average optical gain.

In some embodiments, multiple sol formulations comprising different characteristics are sequentially coated on a substrate to form a multilayer coating with variation, e.g., in pore density, pore sizes, pore shapes, or particles and/or binders characteristics, which is incrementally changed from the substrate to the ambient. For example, the multiple sol formulations can be sequentially coated on a substrate, then dry and heat treated together to form the multilayer coating. Alternatively, each sol formulation can be coated and dried on the substrate to form separate gel coatings. The multiple gel coatings can be heat treated together to form the multilayer coating. Alternatively, each sol formulation can be coated, dried and heat treated at an intermediate temperature (which is less than the temperature of the final heat treatment for forming a sol-gel layer) on the substrate to form separate gel coatings. The multiple gel coatings can be heat treated together at a final temperature to form the multilayer coating. Alternatively, each sol formulation can be coated, dried and heat treated at the final temperature on the substrate to form the multilayer coating.

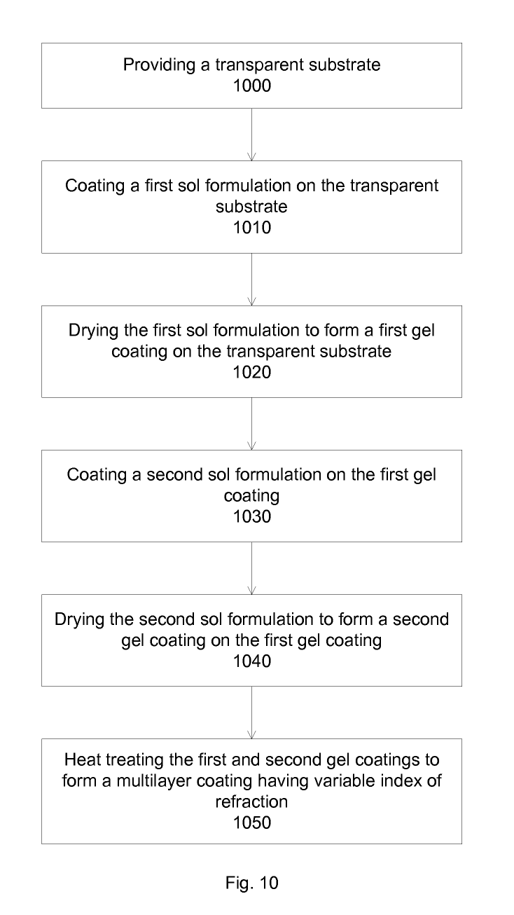

FIG. 10 illustrates another exemplary flowchart to form an antireflective multilayer coating having variable index of refraction according to some embodiments of the present invention. The multilayer coating can be a porous silicon oxide (SiₓO_{y}) coating or a porous titanium oxide (TiₓO_{y}) coating. In operation 1000, a transparent substrate is provided. A sol formulation can be prepared, for example, with a porosity forming agent or with a binder and particles.

The following description provides a preparation of a sol formulation comprising a porosity forming agent. Other sol formulation preparations are similar, for example, by using binders and nanoparticles.

A film forming precursor, an acid or base containing catalyst, and a solvent system containing alcohol and water are mixed to form a reaction mixture by at least one of a hydrolysis and polycondensation reaction. The reaction mixture may be stirred at room temperature or at an elevated temperature (e.g., 50-60 degrees Celsius) until the reaction mixture is substantially in equilibrium (e.g., for a period of 24 hours). The reaction mixture may then be cooled and additional solvents added to reduce the ash content if desired.

In some embodiments, the porosity forming agent may be added to the reaction mixture prior to stirring the reaction mixture. If the porosity forming agent is added to the reaction mixture prior to stirring, the porosity forming agent may play a part in the hydrolysis and condensation reactions. In certain embodiments, the porosity forming agent may be added to the reaction mixture subsequent to stirring the reaction mixture.

In certain embodiments, the porosity forming agent may be accompanied by a surface active agent (e.g., a surfactant) to stabilize and disperse the porosity forming agent in the sol phase of the formulation.

In embodiments where a base catalyst is used, it may be preferable to add the porosity forming agent after stirring the reaction mixture. Sol-gels formed using base catalysts exhibit the formation of particles and that such particles may encapsulate the dendrimers or organic nanocrystals thus limiting or preventing their outgassing upon heating which forms the pores of controllable size and shape.

The use of porosity forming agents allows the control of both the size and shape of the pores in the coating through selection of the molecular geometry of its surfactant molecules and solution conditions such as surfactant concentration, temperature, pH, and ionic strength.

The porous coating layer may contain several types of porosity. Exemplary types of porosity include micropores, mesopores, and macropores. The micropores may be formed when organic material is burned off. The micropores typically have a diameter of less than 2 nanometers. The macropores and mesopores may be formed by packing of the silica nanoparticles. The macropores may have a diameter greater than 50 nanometers. The mesopores may have a diameter between 2 nanometers and 50 nanometers. The porous coating may have a pore fraction of between about 0.3 and about 0.6. The porous coating may have a porosity of between about 20% and about 60% as compared to a solid film formed from the same material.

In operation 1010, a first sol formulation is coated on the transparent substrate. Exemplary substrates include glass, silicon, metallic coated materials, or plastics. The substrate may be a transparent substrate. The substrate could be optically flat, textured, or patterned. The substrate may be flat, curved or any other shape as necessary for the application under consideration. Exemplary glass substrates include high transmission low iron glass, borosilicate glass (BSG), soda lime glass and standard clear glass. The sol-gel composition may be coated on the substrate using, for example, dip-coating, spin coating, curtain coating, roll coating, capillary coating, or a spray coating process. Other application methods known to those skilled in the art may also be used. The substrate may be coated on a single side or on multiple sides.

In operation 1020, the first sol formulation is dried to form a first gel coating. A gel is a coating that has both liquid and solid characteristics and may exhibit an organized material structure (e.g., a water based gel is JELL-O®). During the drying, the solvent of the sol-gel composition is evaporated and further bonds between the components, or precursor molecules, may be formed. The drying may be performed by exposing the coating on the substrate to the atmosphere at room temperature. The coatings (and/or the substrates) may alternatively be exposed to a heated environment at an elevated temperature above the boiling point of the solvent. The drying of the coatings may not require elevated temperatures, but may vary depending on the formulation of the sol-gel compositions used to form the coatings. In one embodiment, the drying temperature may be in the range of approximately 25 degrees Celsius to approximately 200 degrees Celsius. In one embodiment, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used during sol formation.

In operation 1030, a second sol formulation is coated on the first gel coating. The first and second sol formulations comprise a different characteristic to form layers with different indices of refraction. In operation 1040, the second sol formulation is dried to form a second gel coating. In operation 1050, the first and second gel coatings are heat treated to form a multilayer coating, wherein the multilayer coating has an incremental change in index of refraction from that of an ambient to that of the substrate. The annealing temperature and time may be selected based on the chemical composition of the sol-gel compositions, depending on what temperatures may be required to form cross-linking between the components throughout the coating. In one embodiment, the annealing temperature may be in the range of 500 degrees Celsius and 1,000 degrees Celsius. In one embodiment, the annealing temperature may be 600 degrees Celsius or greater. In another embodiment, the annealing temperature may be between 625 degrees Celsius and 650 degrees Celsius. The annealing process may be performed for a time period of between about 3 minutes and 1 hour, for example, about 6 minutes.

The single porous coating may have a thickness about 10 nanometers, or less than about 50 nm. The porous coating may have a thickness between about 5 nanometers and about 1,000 nanometers.

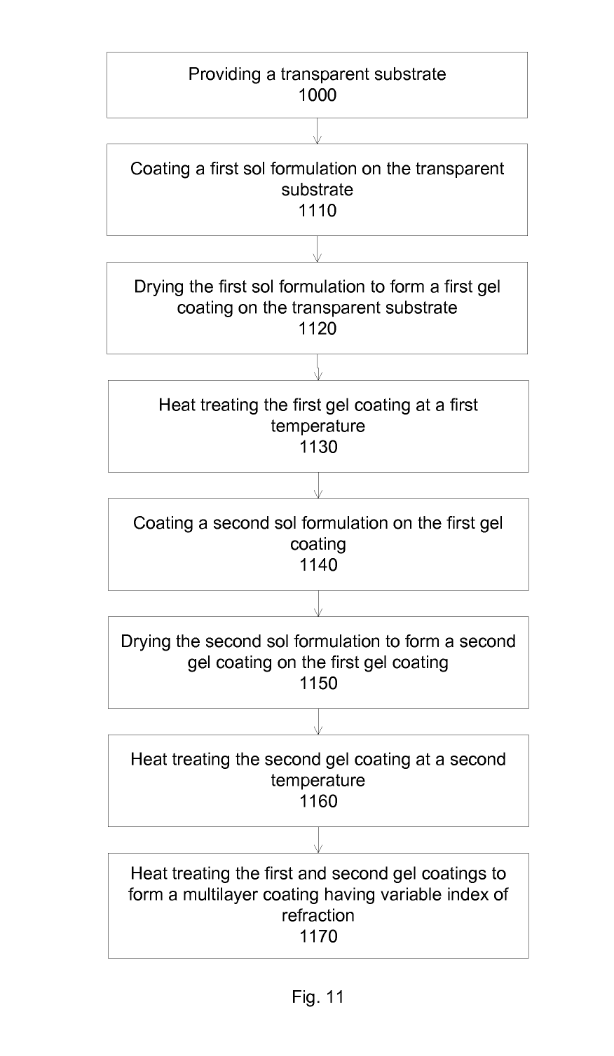

FIG. 11 illustrates another exemplary flowchart to form an antireflective multilayer coating having variable index of refraction according to some embodiments of the present invention. In operation 1100, a transparent substrate is provided. In operation 1110, a first sol formulation is coated on the transparent substrate. In operation 1120, the first sol formulation is dried to form a first gel coating. In operation 1130, the first gel coating is heat treated at a first temperature, which can be less than or equal to a final curing temperature. In operation 1140, a second sol formulation is coated on the first gel coating. The first and second sol formulations comprise a different characteristic to form layers with different index of refraction. In operation 1150, the second sol formulation is dried to form a second gel coating. In operation 1160, the second gel coating is heat treated at a second temperature, which can be less than or equal to a final curing temperature. In operation 1170, the first and second gel coatings are optionally heat treated to form a multilayer coating, wherein the multilayer coating has an incremental change in index of refraction from that of an ambient to that of the substrate.

In some embodiments, multiple sol formulations comprising different characteristics are mixed together before coating on a substrate to form a multilayer coating. For example, the multiple sol formulations can form separate layers or can form an integrated layer having different characteristics.

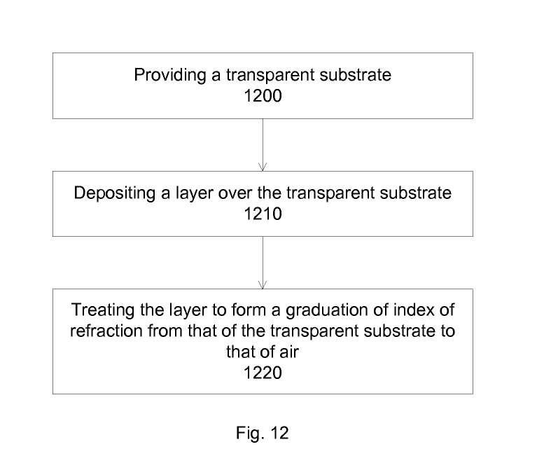

FIG. 12 illustrates an exemplary flowchart to form an antireflective multilayer coating having variable index of refraction according to some embodiments of the present invention. In operation 1200, a transparent substrate is provided. In operation 1210, a layer is deposited over the transparent substrate. In operation 1220, the layer is treated, for example, by thermal energy or by chemical exposure, to form a multilayer coating having variation in index of refraction.

In some embodiments, a sol formulation comprising a porosity forming agent can be used. In general, a porosity forming agent comprises a chemical compound which burns off upon combustion to form a void space or pore. After drying to form the gel coating, a heat treatment process can be used to form a porous coating. For example, the porosity forming agent can decompose or combust to form voids of a desired size and shape upon heating. The porosity forming agent can lead to the formation of stable pores with variable volume and index of refraction. Further, the size and interconnectivity of the pores may be controlled via selection of the porosity forming agent, the total porosity forming agent fraction, polarity of the molecule and solvent, and other physiochemical properties of the gel phase. The porosity forming agent can comprise dendrimers, organic nanocrystals, or a molecular porogen.

In some embodiments, the present invention discloses methods to form multilayer coatings having variable index of refraction with a porosity forming agent. For example, a porosity forming agent, such as a molecular porogen is added, for example, in quantities ranging from 0.01 to 0.1 wt. % in the beginning of a hydrolysis or polycondensation reaction. At the end of such hydrolysis or polycondensation reactions, additional molecular porogen may be added, for example, in quantities ranging from about 0.1 to 5 wt. %. Initial addition of the molecular porogen results in assimilation of the molecular porogen into the polymeric network or matrix prior to aggregation (leading to significantly smaller nanopores upon annealing) and later addition of the self assembling molecular porogen results in molecular aggregation during coating leading to larger pores upon annealing. Thus multilayer coatings having smaller and larger pores, leading to higher and smaller index of refraction, respectively, could be obtained.

In some embodiments, in addition to the porosity forming agent (self-assembling molecular porogen), the sol-gel system further includes a film forming precursor which forms the primary structure of the gel and the resulting solid coating. Exemplary film forming precursors include silicon containing precursors and titanium based precursors. The sol-gel system may further include alcohol and water as the solvent system, and either an inorganic or organic acid or base as a catalyst or accelerator. A combination of the aforementioned chemicals leads to formation of sol through hydrolysis and condensation reactions. Various coating techniques, including dip-coating, spin coating, spray coating, roll coating, capillary coating, and curtain coating as examples, may be used to coat thin films of these sols onto a solid substrate (e.g., glass). During the coating process, a substantial amount of solvent evaporates leading to a sol-gel transition with formation of a wet film (e.g., a gel). Around or during the sol-gel transition, the porosity forming agent can form nanostructures. The deposited wet thin films containing micelles or porogen nanostructures may then be heat treated to remove excess solvent and annealed at an elevated temperature to create a polymerized —Si—O—Si— or —Ti—O—Ti— network and remove all excess solvent and reaction products formed by oxidation of the porosity forming agent, thus leaving behind a porous film with a low refractive index, where n is less than 1.3, to ultra low refractive index where n is less than 1.2.

In some embodiments, a sol formulation comprising a binder and nanoparticles can be used. In some embodiments, the binder comprises a silicon-based binder, such as a silane-based binder. The nanoparticles can comprise silicon-based nanoparticles, such as silane-based nanoparticles. A binder can comprise a component used to bind together, e.g., by adhesion and cohesion, one or more types of materials in mixtures. The binder can comprise inorganic and organic components, for example, an alkyltrialkoxysilane-based binder or a tetraethylorthosilicate (TEOS) binder.

In one embodiment, the sol-formulation may be prepared by mixing a silane-based binder, silica based nanoparticles, an acid or base containing catalyst and a solvent system. The sol-formulation may be formed by at least one of a hydrolysis and polycondensation reaction. The sol-formulation may be stirred at room temperature or at an elevated temperature (e.g., 50-60 degrees Celsius) until the sol-formulation is substantially in equilibrium (e.g., for a period of 24 hours). The sol-formulation may then be cooled and additional solvents added to either reduce or increase the ash content if desired.

After drying to form the gel coating, a heat treatment process can be used to burn off the organic components of the binder. Exemplary inorganic materials remaining after combustion of the organic matter for a sol-formulation can include silica from the nanoparticles and silica from the binder. In general, an increase of the binder in a sol formulation would lead to a reduction in pore fraction and a corresponding increase in the refractive index of the resulting anti-reflective coating. The amount of inorganic components remaining after combustion of the organic matter in the sol formulation is called the ash content of the sol formulation.

The silica binder ash content can affect the refractive index of an anti-reflective coating. Thus sol formulations with different binder or nanoparticles characteristics can provide a coated layer with different index of refraction. For example, higher percentage of silica binder ash content can increase the silica contribution from the binders, as compared to the silica contribution from the silica particles, leading to higher index of refraction.

In some embodiments, multiple sol formulations can be used to form a multilayer coating with variation in index of refraction. For example, the amount of a silane-based binder in the sol-formulations or the total ash content of the sol-formulations can be varied to change the porosity, which will affect the index of refraction. Further, in addition to the ratio of silane-based binder to silica based nanoparticles, specific combinations of particle size and shape are also believed to contribute to the change in refractive index.

In some embodiments, a sol formulation can comprise other components, for example, to form a reaction mixture by a hydrolysis or polycondensation reaction. The mixture can be designed to form multilayer coating with different porosity, resulting in multiple layers or an integrated layer having gradual changing in index of refraction.

In some embodiments, the sol-gel composition can further include an acid or base catalyst for controlling the rates of hydrolysis and condensation. The acid or base catalyst may be an inorganic or organic acid or base catalyst. Exemplary acid catalysts may be selected from the group comprising hydrochloric acid (HCl), nitric acid (HNO₃), sulfuric acid (H₂SO₄), acetic acid (CH₃COOH), and combinations thereof. Exemplary base catalysts include tetramethylammonium hydroxide (TMAH), sodium hydroxide (NaOH), potassium hydroxide (KOH), and the like.

The sol-gel composition can further include a solvent system. The solvent system may include a non-polar solvent, a polar aprotic solvent, a polar protic solvent, and combinations thereof. Selection of the solvent system and the self assembling molecular porogen may be used to influence the formation and size of micelles. Exemplary solvents include alcohols, for example, n-butanol, isopropanol, n-propanol, ethanol, methanol, and other well known alcohols. The solvent system may further include water. The amount of solvent may be from 80 to 95 wt. % of the total weight of the sol-gel composition.

The solvent system may further include water. Water may be present in 0.5 to 10 times the stoichiometric amount need to hydrolyze the silicon containing precursor molecules. Water may be present from 0.001 to 0.1 wt. % of the total weight of the sol-gel composition. Water may be present in 0.5 to 10 times the stoichiometric amount need to hydrolyze the silicon containing precursor molecules.

The sol-gel composition may further include a surfactant. In certain embodiments, the surfactant may be used for stabilizing the sol-gel composition. The surfactant can comprise an organic compound that lowers the surface tension of a liquid and contains both hydrophobic groups and hydrophilic groups. Thus the surfactant contains both a water insoluble component and a water soluble component. The surfactant may also be used to stabilize colloidal sols to reduce the precipitation of solids over extended periods of storage.

The sol-formulation may further include a gelling agent or solidifier. The solidifier may be used to expedite the transition of a sol to a gel. It is believed that the solidifier increases the viscosity of the sol to form a gel. The solidifier may be selected from the group comprising: gelatin, polymers, silica gel, emulsifiers, organometallic complexes, charge neutralizers, cellulose derivatives, and combinations thereof.

In some embodiments, the present invention discloses application of different heat treatments, use of porosity forming agent, binders, nanoparticles, surfactants, etc. to further control the gradation in the multilayer coating having variation in index of refraction.

In some embodiments, different organic porogens, surfactants and binders can be used to provide control in forming the gradual index of refraction. For example, in some embodiments, the porous antireflective coatings can comprise a molecular porogen which may be a self assembling molecular porogen where different pore sizes can be obtained in one annealing step. The porous antireflective coatings can be achieved with a sol-gel composition comprising at least one self assembling molecular porogen and removing the at least one self assembling molecular porogen to form the porous coating. In some embodiments, the porous antireflective coatings can comprise at least one porosity forming agent, such as dendrimers and organic nanocrystals, which can be removed during the anneal process to form the porous coatings. The porous antireflective coatings can be achieved with a sol-gel composition comprising a porosity forming agent, such as dendrimers and organic nanocrystals, together with a heat treatment process to control the porosity of the antireflective coatings. In some embodiments, the porous antireflective coatings can comprise an alkyltrialkoxysilane-based binder. The porous antireflective coatings can be achieved with a sol-gel composition comprising an alkyltrialkoxysilane-based binder, together with a heat treatment process to control the porosity of the antireflective coatings.

In some embodiments, the present invention discloses approaches to form the graded antireflective coating. The present coating can comprise silica particles of different shapes, sizes and porosities in different layers. For example, spherical particles can lead to index of refraction ranging of 1.3 to 1.37. Elongated particles (e.g., IPA-ST-UP) can lead to index of refraction ranging from 1.18 to 1.28. Disc shaped particles (Laponite) can lead to index of refraction ranging from 1.2 to 1.5. Porous/hollow silica nanopaticles can lead to index of refraction ranging from 1.2 to 1.5.

In some embodiments, a combination of sol formulations containing mixed particles could lead to a graded antireflective layer. Alternately, different sol gel formulations can be employed in a multiple coating steps approach to achieve desired antireflective gradation using individual or combinations of aforementioned particles containing sol formulations. The present coating can comprise sol formulations with different binders and organic porogens. For example, TEOS containing sols can lead to layers having index of refraction about 1.45. N-hexyltriethoxysilane and cyclohexyltrimethoxysilane can lead to layers having index of refraction as low as about 1.35. In addition, addition of organic porosity forming agent, surfactants could provide additional controls variations to further control the index of refraction of the graded antireflective coating.

In some embodiments, the present invention discloses temperature processes to achieve coating having gradual index of refraction. In some embodiments, different heat treatment conditions after application of sol gel AR coating (single or multilayered) could provide control over the gradation of index of refraction. For example, a multilayered gel using various particles containing sol formulations and/or various binders could be heat treated using different time, temperature and ramp/cool down rates in order to achieve inter-diffusion between gel multi-layers, leading to index of refraction gradation. In some embodiments, chemical curing conditions can be tailored to form a multilayer with gradual index of refraction. For example, varying surface driven diffusion controlled chemical curing conditions for the binder in the wet coating applied on the surface may lead to diffusion and chemical reaction driven gradation of the index of refraction in the coating. The chemical curing (instead of or in addition to heat curing) of the coatings can be performed in a controlled atmosphere containing curing agent such as ammonia, generating gradual porosity in the coated layer, with larger pores (and lower index of refraction) nearer the surface.

In some embodiments, different heat treatment conditions after application of sol gel antireflective coating (single or multilayered) could provide even further control over the gradation of index of refraction. For example, a multilayered gel using various particles containing sol formulations and/or binders could be heat treated using different time, temperature and ramp/cool down rates in order to achieve inter-diffusion between gel multi-layers leading to gradation of index of refraction.

In some embodiments, the present invention discloses the use of surface driven diffusion controlled chemical curing conditions for the binder in the wet coating applied on the surface may lead to diffusion and chemical reaction driven gradation of the index of refraction in the antireflective coating. For example, graded index of refraction can be obtained by chemical curing (instead of heat curing) of the antireflective coatings in a controlled atmosphere containing curing agent such as ammonia.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method of making a coated article, the method comprising:
providing a transparent substrate;
depositing two or more layers over the transparent substrate,
wherein each of the two or more layers comprises an index of refraction between the index of refraction of the transparent substrate and the index of refraction of air,
wherein the indices of refraction of the two or more layers are varied from that of the transparent substrate to that of air.

2. A method as in claim 1, wherein the two or more layers comprise 8 or more layers having a same thickness.

3. A method as in claim 1, further comprising
depositing two or more second layers over the transparent substrate at an opposite side of the transparent substrate,
wherein each of the two or more second layers comprises an index of refraction between the index of refraction of the transparent substrate and the index of refraction of air,
wherein the indices of refraction of the two or more second layers are varied from that of the transparent substrate to that of air.

4. A method as in claim 1, wherein depositing the two or more layers comprises controlling at least a characteristic of the deposition or of the material of the two or more layers.

5. A method as in claim 4, wherein controlling at least a characteristic of the material of the two or more layers comprises changing a size, a shape or a porosity of embedded particles in each of the two or more layers.

6. A method as in claim 4, wherein controlling at least a characteristic of the material of the two or more layers comprises changing an organic porogen, a surfactant, or a binder in each of the two or more layers.

7. A method as in claim 4, wherein controlling at least a characteristic of the deposition of the two or more layers comprises a heat treatment condition or a surface curing reaction of the two or more layers.

8. A method as in claim 1, further comprising
heat treating the two or more layers.

9. A method as in claim 1, further comprising
heat treating each of the two or more layers individually.

10. A method of making a coated article, the method comprising:
providing a transparent substrate;
depositing a layer over the transparent substrate;
treating the layer to form a graduation of index of refraction from the index of refraction of the transparent substrate to the index of refraction of air.

11. A method as in claim 10, wherein the index of refraction of the layer is linearly, step-wise, or smoothly changed from that of the transparent substrate to that of air.

12. A method as in claim 10, wherein treating the layer comprises changing a size, a shape or a porosity of embedded particles in the layer.

13. A method as in claim 10, wherein treating the layer comprises changing an organic porogen, a surfactant, or a binder in the layer.

14. A method as in claim 10, wherein treating the layer comprises a heat treatment condition or a surface curing reaction of the layer.

15. A method as in claim 10, wherein treating the layer comprises heating the layer in an ammonia ambient to achieve a gradation of porosity in the layer.

16. A coated article comprising:
a transparent substrate;
two or more layers deposited over the transparent substrate,
wherein each of the two or more layers comprises an index of refraction between the index of refraction of the transparent substrate and the index of refraction of air,
wherein the indexes of refraction of the two or more layers are varied from that of the transparent substrate to that of air.

17. An article as in claim 16, wherein the two or more layers comprise 8 or more layers.

18. An article as in claim 16, wherein the two or more layers comprise a same thickness.

19. An article as in claim 16, wherein each of the two or more layers has a thickness of less than 300 nm.

20. An article as in claim 16, wherein the two or more layers form an integrated layer having a gradation in the index of refraction.
